(19) United States
(12) Patent Application Publication
(10) Pub. No.: US 2009/0166417 A1
(43) Pub. Date: Jul. 2, 2009

(54) System and Method for Independently Auditing a Paper Record of Votes Cast on a Voting Machine

(76) Inventors: Michael Dammann, Papillion, NE (US); Robert Thiem, Lincoln, NE (US)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 11/965,534

(22) Filed: Dec. 27, 2007

(51) Int. Cl. G07C 13/00

(52) U.S. Cl. 235/386

(57) ABSTRACT

A system for independently auditing a paper record of votes cast on a voting machine includes an automated reading device and a computing device. The automated reading device comprises a transport mechanism operable to move the paper record across a paper transport area, and a reader operable to read at least a portion of the paper record as it moves across the paper transport area. Preferably, the automated reading device includes a control panel that allows a user to operate the transport mechanism, and a viewing window that allows a user to view the paper record as it moves across the paper transport area. The computing device is operable to receive data from the automated reading device, process at least a portion of the data to generate vote tallies for the voting machine, and output at least a portion of the data and/or vote tallies for review by a user.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates generally to voting systems, and, more particularly, to a system and method for independently auditing a paper record of votes cast on a voting machine.

2. Description of Related Art

Voting machines or voting terminals are commonly provided by election officials to allow voters to cast their votes in elections. Voting machines employing manual vote-recording techniques, such as punching a hole through a voting card to record a vote for a particular candidate, are still used. However, many jurisdictions have turned to electronic voting machines (such as direct recording electronic (DRE) voting machines) to automate and expedite the tallying of votes. Because the votes are tallied electronically, many jurisdictions require that the electronic voting machine provide a voter-verifiable paper record of votes cast on the voting machine. For example, the paper record may comprise a plurality of voting records each of which corresponds to a voting session of a voter. Each voter is able to review his/her voting record and verify that the votes have been recorded correctly. Thus, the paper record provides a record of the votes cast on the voting machine such that the paper record can be compared to the electronic records and vote tallies of the voting machine for auditing purposes.

### BRIEF SUMMARY OF THE INVENTION

The present invention is directed to a system and method for independently auditing a paper record of votes cast on a voting machine. The paper record may be in the form of a continuous paper roll of voting records associated with the voting machine. Alternatively, the paper record may be in the form of individual paper sheets each of which comprises one of the voting records associated with the voting machine. Other forms of paper records are also within the scope of the invention. Regardless of the form of the paper record, each of the voting records presents voting session information that is human-readable (e.g., a vote summary that can be reviewed and verified by the voter) and/or machine-readable (e.g., a barcode comprising an encoded representation of the vote summary).

In one aspect of the invention, a reading device is provided for reading the voting records on the paper record. The reading device includes a transport mechanism operable to move the paper record across a paper transport area, and a reader operable to read at least a portion of the paper record as it moves across the paper transport area. In an exemplary embodiment, the reader comprises a barcode reader operable to read one or more barcodes presented on each of the voting records. The reading device then generates and outputs data corresponding to the information read from the paper record.

In another aspect of the invention, a computing device is provided that receives the data from the reading device. The computing device is operable to process the data to generate vote tallies for the voting machine, and output the data and/or vote tallies in various desired formats for review by a user. In an exemplary embodiment, the data and/or vote tallies are displayed on a computer screen and printed on a printable medium. The data and/or vote tallies can then be compared to the electronic records and vote tallies of the voting machine for auditing purposes.

Importantly, the system of the present invention operates independently and separately from the voting machine that produced the paper record to allow independent auditing of the electronic records and vote tallies of the voting machine.

### BRIEF DESCRIPTION OF THE DRAWINGS

The present invention will be described in greater detail in the following detailed description of the invention with reference to the accompanying drawings that form a part hereof, in which:

FIG. 1 is a perspective view of a reading device in accordance with a first exemplary embodiment of the present invention.

FIG. 2 is a top view of the reading device of FIG. 1.

FIG. 3 is a side-perspective view of the reading device of FIG. 1 with the cover for the paper-handling portion in a raised position.

FIG. 4 is a side view of the reading device of FIG. 1 with the cover for the control portion in a raised position.

FIG. 5 is a perspective view of the reading device of FIG. 1 with both covers in a raised position.

FIG. 6 is a perspective view of a reading device in accordance with a second exemplary embodiment of the present invention.

FIG. 7 is a block diagram of an exemplary reading device and computing device in accordance with the present invention.

FIGS. 8 and 9 are plan views of first and second pages of a voting record in accordance with an exemplary embodiment of the present invention.

FIG. 10 is a perspective view of a series of fan-fold connected pages of a voting record in accordance with an exemplary embodiment of the present invention.

FIG. 11 is a perspective view of a continuous paper roll of voting records in accordance with an exemplary embodiment of the present invention.

FIG. 12 is a screen shot of a voting session report in accordance with an exemplary embodiment of the present invention.

FIG. 13 is a screen shot of a vote tally report in accordance with an exemplary embodiment of the present invention.

FIG. 14 is a screen shot of a terminal summary report in accordance with an exemplary embodiment of the present invention.

### DETAILED DESCRIPTION OF EXEMPLARY EMBODIMENTS OF THE INVENTION

The present invention is directed to a system and method for independently auditing a paper record of votes cast on a voting machine. While the invention will be described in detail below with reference to various exemplary embodiments, it should be understood that the invention is not limited to the specific configurations or methodologies of these embodiments. In addition, although the exemplary embodiments are described as embodying several different inventive features, one skilled in the art will appreciate that any one of these features could be implemented without the others in accordance with the invention.

### First Exemplary Embodiment

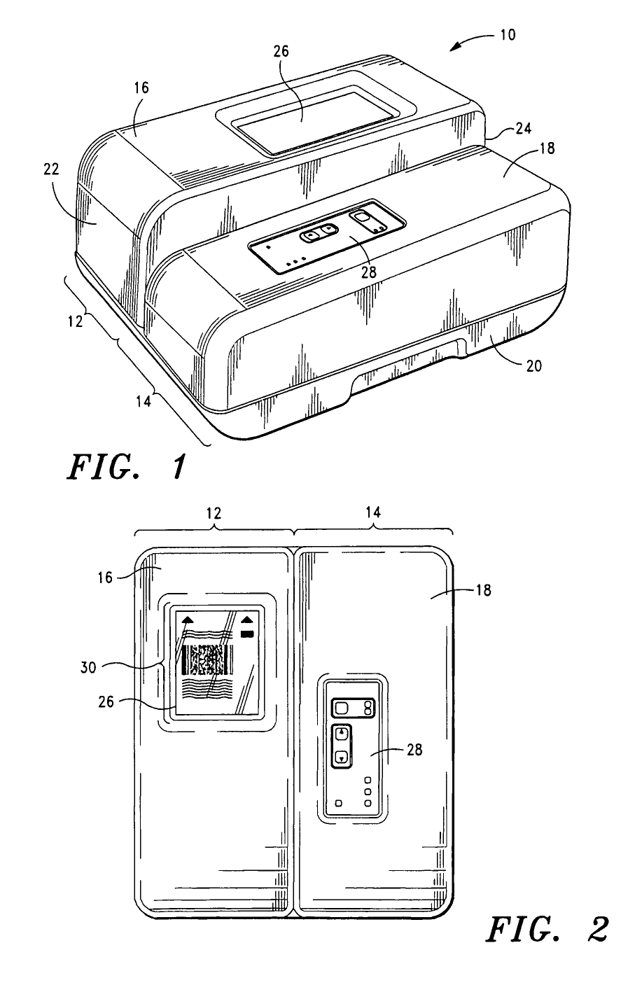

A device for independently auditing a paper record of votes cast on a voting machine in accordance with a first exemplary embodiment of the present invention is depicted in FIGS. 1-5, designated generally as reference numeral 10. Looking first to FIG. 1, device 10 includes an enclosure that divides the device generally into a paper-handling portion 12 and a control portion 14. As will be described in more detail hereinbelow, paper-handling portion 12 generally includes the components and mechanisms responsible for transporting and reading the paper record, while control portion 14 generally includes the control circuitry and logic operable to control the operation of the paper-handling portion 12.

Covers 16 and 18 enclose and cover the paper-handling and control portions 12 and 14, respectively, with the covers being hingedly attached to bottom piece 20 along the rear 24 of the device. As such, covers 16 and 18 can be independently raised to access the corresponding areas within the device.

In the exemplary embodiment depicted, cover 16 may be raised by a user so that paper rolls of voting records (described in more detail hereinbelow) can be loaded into the paper-handling portion 12 of the device. As best seen in FIG. 2, a transparent viewing window 26 is positioned within the top portion of cover 16, over the paper-handling portion of the device, allowing a user to view a paper record 30 as it is transported through the device. Window 26 is preferably a rigid, substantially transparent material, such as plastic or glass, positioned within a recessed area formed around an opening in cover 16 so that the window 26 lies substantially flush with the top surface of cover 16.

A control panel 28, having user-operable controls and indicators, is positioned in the top portion of cover 18, over the control portion of the device. In use, cover 18 is closed and secured with tamper-resistant screws to prevent access to the control portion of the device. As will be described in more detail hereinbelow, a tamper detection switch in communication with control circuitry detects any opening of cover 18. When cover 18 is opened, a tamper indicator is logged into the memory of the control circuitry, an alert is provided that the security of the device has been compromised, and operation of the device is disabled.

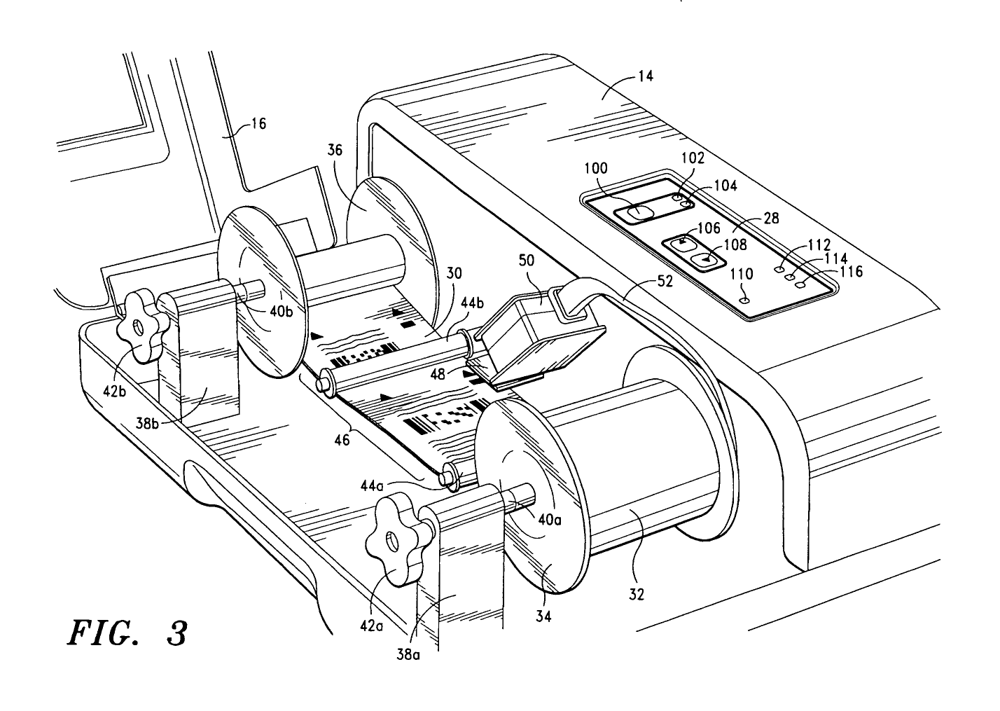

With the device being generally set forth, and looking now to FIG. 3, with cover 16 raised, the paper-handling portion of the device can be seen to include a paper supply reel 34 and a paper take-up reel 36, with a paper roll 32 extending between and wound around each of the two reels. Paper roll 32 includes a plurality of voting records 30, wherein each voting record comprises indicia printed on the paper representing votes cast by a voter during a particular voting session. In other words, paper roll 32 includes voting records corresponding to multiple voting sessions, each being a record of votes cast by a voter during a voting session as recorded on the paper roll 32 by the voting machine used to cast the votes. A paper roll 32 typically includes multiple voting records from a single voting machine. Of course, it should be understood that there may be multiple paper rolls from a single voting machine in an election.

Looking still to FIG. 3, extending through and secured to supply reel 34 and take-up reel 36 are spindles 40a and 40b, respectively. Each spindle 40a, 40b extends through and is secured within and supported by a support member 38a, 38b, with a knob 42a, 42b secured at the outer end of each spindle to allow manual turning of the spindle and corresponding reel. As will be described in more detail hereinbelow, the inner end of each spindle (not shown) is connected to a corresponding stepper motor that allows rotation of the spindles (and thus the reels) using electronic control circuitry to advance the paper from the supply reel 34 to the take-up reel 36.

Looking still to FIG. 3, two paper-guide rollers 44a, 44b are positioned above the paper record 32 to guide the paper as it travels between the two reels 34 and 36. The area between the reels defines a paper transport area 46 in which the paper record 32 is extended so that the indicia on the paper is exposed so that it can be viewed by a user and/or read by the device. As described above, with cover 16 closed, the paper record 32 extended across paper transport area 46 is viewable through window 26. Positioned above the paper transport area 46, over the paper record 32, are a sensor board 48 operable to detect the presence of paper in the paper transport area 46 and/or to detect timing marks on the paper, and a reader 50 operable to electronically read at least a portion of the indicia on the paper (e.g., the barcodes) and translate that indicia to electronic data. Cable 52 connects reader 50 to the control portion 14 of the device so that the electronic data can be transferred from reader 50 to a controller/logic board, which is operable to further transmit that data to an external computer system (as will be described in more detail hereinbelow).

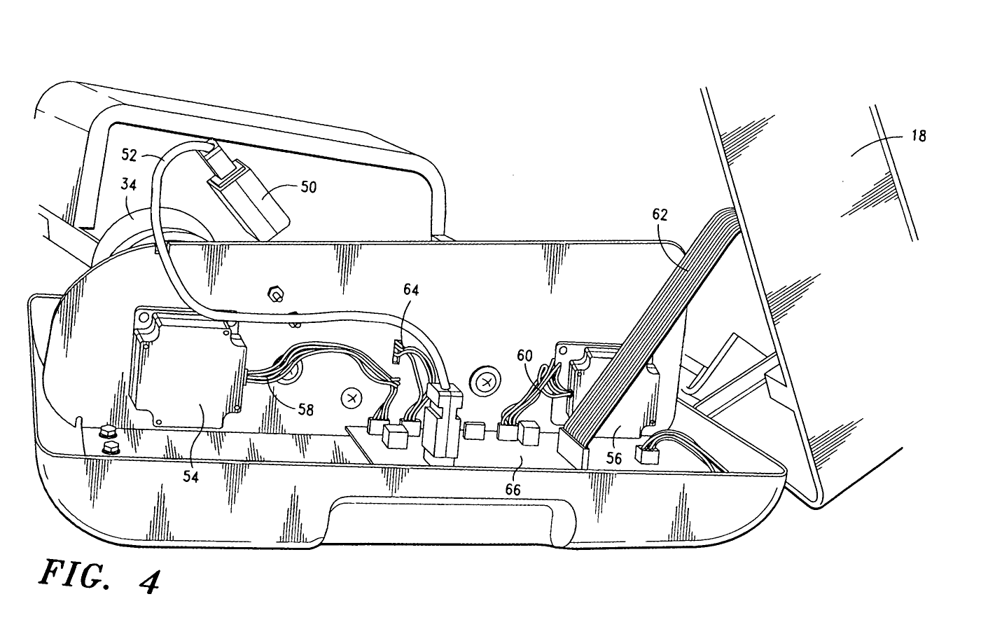

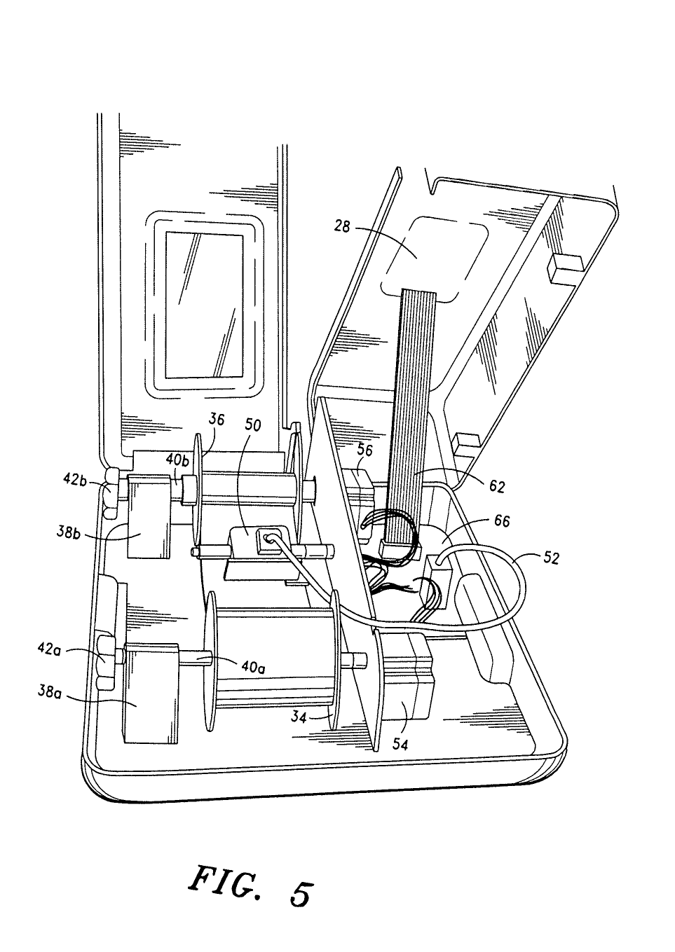

Looking now to FIG. 4, with reference back to FIG. 3, within the control portion 14 of the device are stepper motors 54 and 56, corresponding to the supply reel 34 and take-up reel 36, respectively, as described above. The stepper motors 54 and 56 are mounted to a vertical panel separating the paper-handling portion 12 from the control portion 14 of the device. As described above, spindles 40a, 40b extending through and supporting the supply and take-up reels 34 and 36, are attached to the shaft of the corresponding stepper motors 54 and 56 so that the motors can be operated to control the rotation of the associated spindle and reel. Thus, the transport of the paper roll 32 across paper transport area 46 can be controlled by simultaneously controlling the movement of the stepper motors 54 and 56 to advance or retract the paper roll 32 on the reels. Cables 58, 60 connect the stepper motors 54, 56 to control circuitry on controller/logic board 66, positioned at the bottom of the control portion 14 compartment.

Controller/logic board 66 provides appropriate power supply circuitry operable to provide power to the various components of the device, and control circuitry to communicate with the various components of the device. The controller/logic board 66 further includes a microcontroller and associated memory programmed to control the operation of the device as described herein. Control and interface circuitry on the controller/logic board 66 and interconnecting cabling allow the microcontroller to communicate with and/or control the various components located throughout the device. Cable 64 connects the controller/logic board 66 to the sensor board 48 located in the paper-handling portion 12, and cable 52 connects the controller/logic board 66 to the reader 50 located in the paper-handling portion 12. Cable 62 connects the controller/logic board 66 to the underside of the control panel 28, located in the cover 18 as previously described. The cables provide electrical communication between interface circuitry on the controller/logic board 66 and the associated component to allow the controller/logic circuitry to control and/or monitor the component.

FIG. 5 provides an end-perspective view of the device with both covers 16, 18 open, showing the components and cabling as described above.

Looking back to FIG. 3, the control panel 28 includes multiple user-operable controls, along with multiple indicator lights. The user-operable controls allow the user to control the device (as will be described in more detail hereinbelow), while the indicator lights allow the user to monitor various aspects of the device's operation (as will also be described in more detail hereinbelow). Control panel 28 is preferably a unitary panel positioned within a recessed area formed around an opening in cover 18 so that the controls and indicators lie substantially flush with the top surface of the cover 18 and so that the underside of the control panel 28 is accessible to the interior of the device. As described above, the control panel 28 is in electrical communication with the controller/logic board 66 so that pressing a switch on the control panel 28 is detectable by the controller/logic board 66 and so that the lights on the control panel may be illuminated or extinguished upon command from the controller/logic board 66. The switches on the control panel 28 are preferably membrane type pushbutton switches, and the indicator lights are preferably light-emitting diodes (LEDs). Most preferably, the control panel 28 is formed as a single unit covered by a water-resistant upper membrane, and is configured to fit within a recessed area formed around an opening in cover 14. Of course, other types of switches and lights may be used, and the layout and configuration of the control panel may be varied, without deviating from the scope of the present invention.

Looking to the control panel 28 depicted in FIG. 3, a “power” indicator light 110 provides a visual indication that the device is powered on. Located at the top edge of the control panel is a “mode” switch 100, which is a membrane type pushbutton switch. In conjunction with “manual” and “auto” indicator lights 102 and 104, the “mode” switch 100 allows the user to toggle the device to either manual or automatic mode. Pressing the “mode” switch 100 signals the controller/logic board 66 to toggle operation between “manual” and “automatic” mode, and to light the indicator light 102 and 104 corresponding to the selected mode. In manual mode, the “forward” 106 and “reverse” 108 buttons are enabled to allow the user to advance or retreat the paper roll 32 between the reels. In automatic mode, the paper roll 32 will advance between the reels under the control of the controller/logic board 66, with the “forward” 106 and “reverse” 108 buttons being disabled to prevent user operation during “automatic” mode. Along the lower right-hand side of the control panel 28 are indicator lights labeled “read” 112, “security” 114, and “error” 116, which allow the controller/logic board 66 to provide a visual indication to a user when a barcode is being read, when a security (i.e., tamper switch) breach has been detected, and when an error in reading a barcode has occurred, respectively.

In an alternative embodiment, the device may be used to manually review paper records of votes cast on a voting machine. In this embodiment, the paper transport and control mechanisms are essentially identical to those just described for the first exemplary embodiment. However, in this embodiment, the sensor board 48 and reader 50 are not employed, and the “automatic” mode of operation is disabled. A user, using the “forward” 106 and “reverse” 108 buttons as previously described, transports the paper roll 32 through the device, viewing the paper record 32 through the viewing window 26 and reading the human-readable indicia thereon. In this embodiment, the electronically-readable indicia (i.e., the barcodes) are not read, and no electronic data is transmitted from the device. Preferably, in this alternative embodiment, pressing the “forward” 106 and “reverse” 108 buttons will cause the paper roll 32 to advance or retract, for example, seven inches, the length of an exemplary voting record. Of course, other lengths of voting records may be used and the automatic advance/retract length can be varied accordingly. Thus, a user can advance the next voting record into the viewing window 26 by simply pressing the “forward” 106 button one time. It will be apparent to those skilled in the art that this embodiment could be manufactured to omit the sensor board 48 and reader 50 altogether, or to include a modified control panel that omits the “automatic” mode functionality, or may simply be identical to the reader of the first exemplary embodiment described above with the “automatic” mode disabled. It will also be apparent to those skilled in the art that the first exemplary embodiment described above could simply be used in a “manual” mode, wherein the electronic data decoded from the barcodes would be ignored (in which case there would be no need for the computer system described below).

### Second Exemplary Embodiment

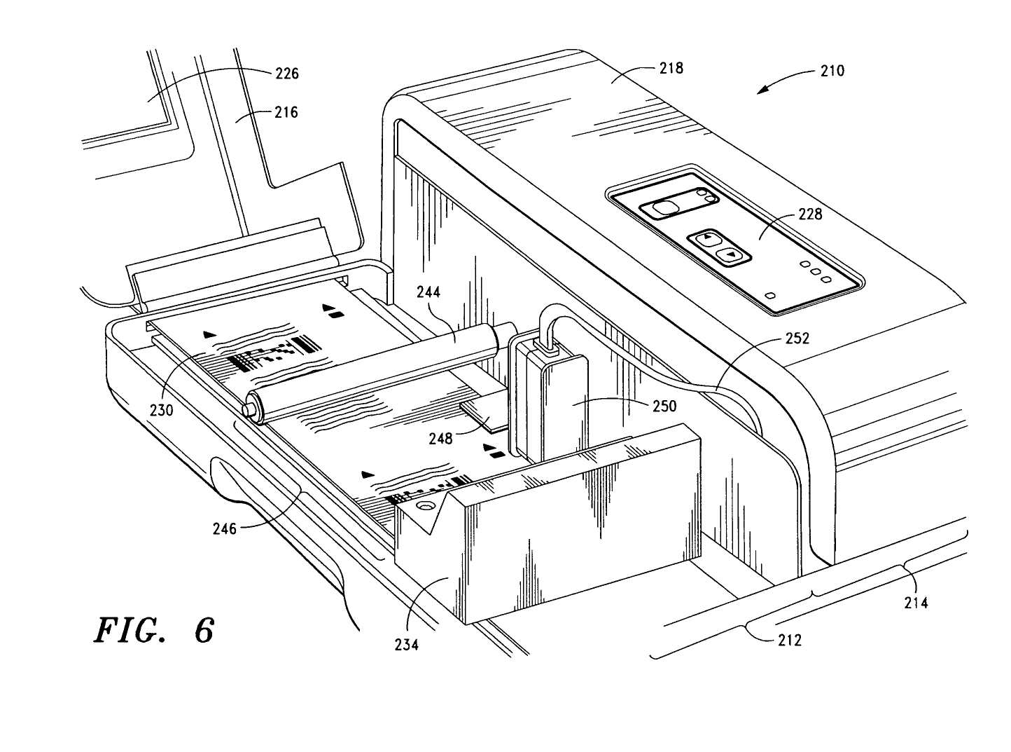

A device for independently auditing a paper record of votes cast on a voting machine in accordance with a second exemplary embodiment of the present invention is depicted in FIG. 6, designated generally as reference numeral 210. As will be apparent, the device of the second exemplary embodiment is similar to the device of the first exemplary embodiment described above.

Looking to FIG. 6, device 210 includes an enclosure that divides the device generally into a paper-handling portion 212 and a control portion 214. The paper handling portion 212 generally includes the components, circuitry and mechanisms responsible for transporting a paper record through the device, and control portion 214 generally includes the control circuitry and logic operable to control and communicate with the paper-handling portion 212.

Covers 216 and 218 enclose and cover the paper-handling and control portions 212 and 214, respectively, with the covers being hingedly attached to the bottom piece along the rear of the device. As such, each cover 216, 218 can be independently raised to access the corresponding area within the device. A transparent viewing window 226 is positioned within the top portion of cover 216, over the paper-handling portion 212 of the device, allowing a user to view a paper record 230 as it is transported through the device. A control panel 228, having user-operable controls and indicators, is positioned in the top portion of cover 218, over the control portion 214 of the device. In use, cover 218 is closed and secured with tamper-resistant screws to prevent access to the control portion 214 of the device.

In this second exemplary embodiment, the paper-handling portion 212 can be seen to include a single sheet feed drive 234 operable to pull the paper record 230 through the device. In this embodiment, paper record 230 comprises a plurality of individual paper sheets (wherein each paper sheet includes one or more pages in a fanfold configuration). Each of the individual paper sheets comprises a voting record with indicia printed on the paper representing the votes cast in a voting session on the voting machine. In a manner analogous to that described above with respect to the first exemplary embodiment, feed drive 234 is operable and controllable to transport the individual paper sheets through the device.

Looking still to FIG. 6, a paper guide roller 244 is positioned above the paper record to guide the paper as it travels through the device, across paper transport area 246. Positioned above the paper transport area 246, over the paper record, are a sensor board 248 operable to detect the presence of paper in the paper transport area 246 and/or to detect timing marks on the paper, and a reader 250 operable to read at least a portion of the indicia on the paper record (e.g., barcodes) and translate that indicia to electronic data. Cable 252 connects reader 250 to the control portion 214 of the device so that the electronic data can be transferred from reader 250 to a controller/logic board, which is operable to further transmit that data to an external computer system (as will be described in more detail hereinbelow).

The control portion 214 of the device is similar to that described above with respect to the first exemplary embodiment, except that feed drive 234 replaces the stepper motors to transport the paper record through the device. As with the first exemplary embodiment, a controller/logic board in the device provides appropriate power supply circuitry operable to provide power to the various components of the device, and control circuitry to communicate with the various components. The controller/logic board includes a microcontroller and associated memory programmed to control the operation of the device as described herein. Interfaces and cabling to the components are similar to that described above with respect to the first exemplary embodiment.

Control panel 228 includes the user-operable controls and indicator lights as describe above with respect to the first exemplary embodiment. However, in this embodiment, the “manual” mode of operation is disabled so that only the “automatic” mode of operation is available to a user. Of course, one skilled in the art will appreciate that the same control panel could be used for each device, with the “manual’ mode of operation and corresponding buttons disabled via hardware and/or software. Alternatively, a separate control panel that excludes the “manual” controls could be used for the second exemplary embodiment.

### Functional Block Diagram

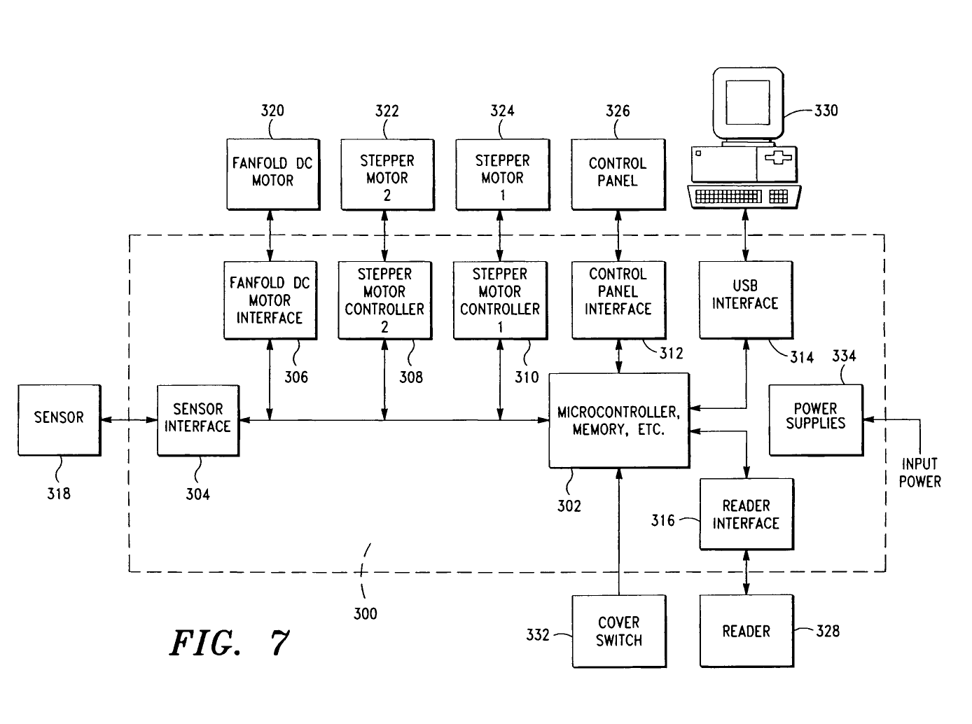

Looking now to FIG. 7, in conjunction with the components of the device as just described, a functional block diagram depicts the interrelationship of the components and circuitry of the devices described above. Controller/logic board 300 includes a microcontroller and memory 302 and associated circuitry for controlling the device. The microcontroller is preferably a low power, high speed processor capable of controlling multiple input and output devices, and programmed with instructions to implement the functions described herein. Most preferably, it is a Freescale MXS portable processor. On startup, the microcontroller performs a system initialization procedure, including testing the memory, loading the executable instructions from ROM into RAM, testing the input/output interfaces, and other typical start-up tasks. The microcontroller is also operable to monitor operation of the device and to log any errors to memory for later transmission as error reports to an external computer system 330 (as described in more detail hereinbelow).

Power supply circuitry 334 receives input power from an external source, such as an AC line power, and provides the appropriate AC and DC power to the circuitry on the control board and to the components of the device (thorough the cabling to the components, as described above). Sensor interface 304 provides interface circuitry allowing communication between the sensor board and the microcontroller. Similarly, the control panel interface 312 and reader interface 316 circuitry allow communication between the microcontroller and the respective components. Stepper motor controller 1 (310) and stepper motor controller 2 (308) circuitry allows the controller/logic board to control the stepper motors 54, 56 of the device of the first exemplary embodiment (which rotate the supply and take-up reels). Fanfold DC motor interface circuitry 306 allows the controller/logic board to control feed drive 234 of the second exemplary embodiment. Universal Serial Bus (USB) interface circuitry 314 provides a standard serial interface between the microcontroller on the controller/logic board and any other device that has a USB interface, such as external computer system 330 as shown in FIG. 7. Preferably, the USB interface implements the USB 1.1 protocol or later version. The USB interface allows the microcontroller on the controller/logic board to transfer electronic data read from the paper record to computer system 330 so that the data can be tallied, displayed, printed and otherwise reported.

### Paper Records

FIGS. 8-11 depict various types of paper records that may be read by the devices of the present invention. As described above, a paper record generated by a voting machine is essentially a printed record of the votes cast by voters on the voting machine. The paper record may be in the form of a continuous paper roll of voting records, a plurality of individual paper sheets each of which corresponds to a voting record, or other formats known in the art.

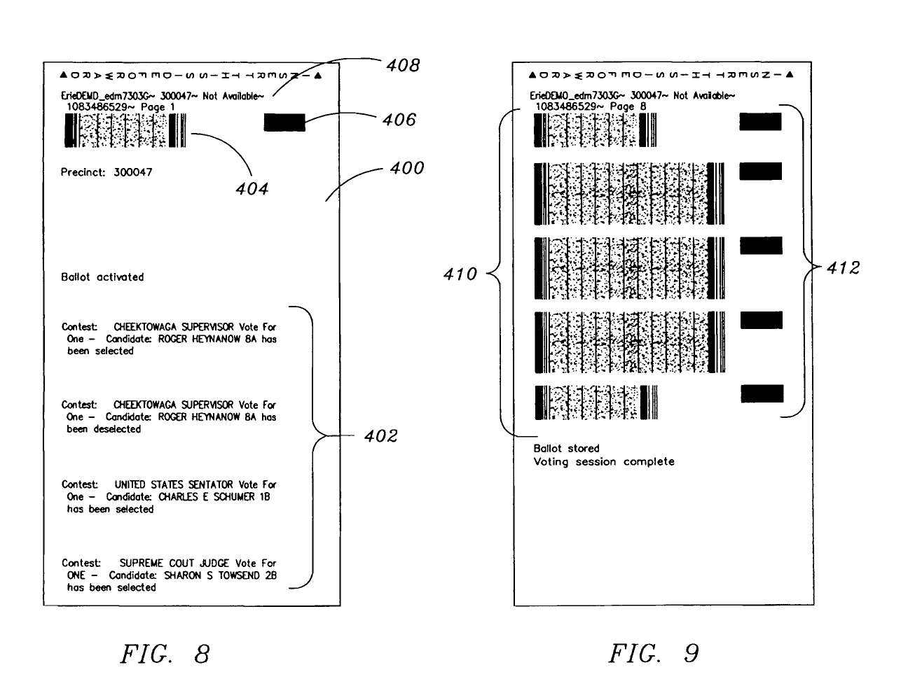

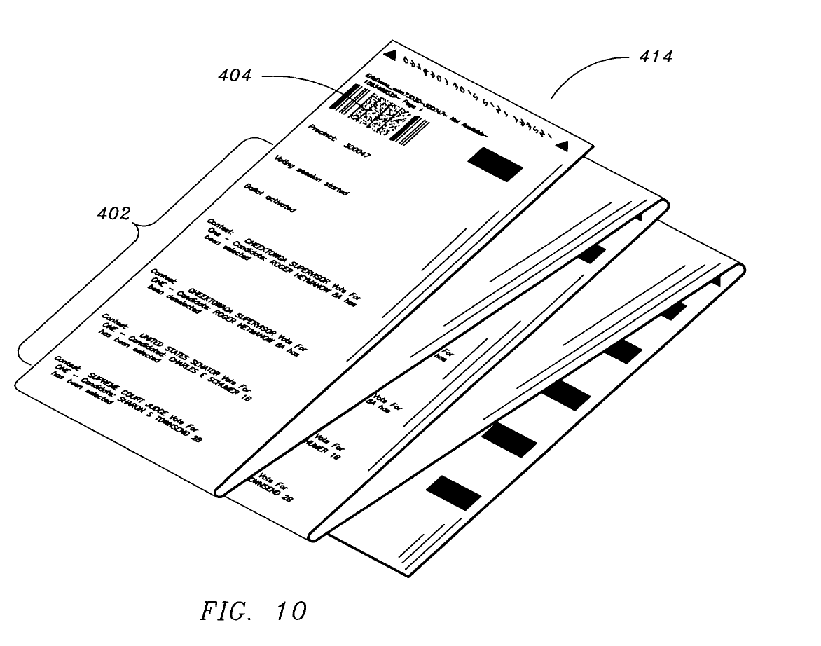

Looking to FIGS. 8 and 9, a voting record in the form of an individual paper sheet (with two inter-connected pages) includes numerous printed indicia representing information corresponding to a voting session. Looking to FIG. 8, an exemplary first page 400 of the voting record includes human-readable indicia 402 indicating the votes that were cast in the voting session. The human-readable indicia is typically printed text that allows a user to review and verify the votes printed on the voting record. Other human-readable indicia printed on the voting record may include: a unique voting session identifier correlating the printed voting record to an electronic record stored in the memory of the voting machine, the title of the election, a time and/or date stamp for the voting session, the polling location where the voting terminal is located, the style of ballot used in the election, the voting terminal identification number (i.e., serial number), the polling location open and close times, the number of terminals located at the polling place, and a list of voting items (i.e., races) in the election. It should be understood that this list is exemplary and not all of the listed information need be printed on every voting record. Further, this list is not exhaustive insofar as other types of information may be printed on the voting record. Generally, at a minimum, the voting record will include at least a unique voting session identifier and a summary of votes cast during a voting session.

In addition to the human-readable indicia, the first page 400 of the voting record may include machine-readable indicia, such as a barcode 404. A timing mark 406 serves as an indicator that a barcode is present at that location on the voting record. Barcode 404 comprises encoded data that may include all of the information represented by the human-readable indicia printed on the voting record, may include a subset of that information, or may include information in addition to that information. The voting record may include several pages similar to that depicted in FIG. 8, with each page having human-readable indicia and machine-readable indicia representing the votes cast and other information relating to the voting session. While the exemplary voting record includes a two-dimensional barcode as a machine-readable indicia, it will be understood that other machine-readable indicia, such as magnetically encoded indicia, optical character recognition (OCR) indicia, or other machine-readable indicia may be used instead of a barcode, or that combinations of various machine-readable indicia may be used without deviating from the scope of the present invention.

As depicted in FIG. 9, the second page of the voting record includes multiple barcodes 410 that provide a summary of the entire voting session. The information encoded in the multiple barcodes 410 may duplicate some of the information provided on the preceding pages to allow the entire voting record to be correlated and verified. Again, timing marks 412 on the second page provide an indication to the sensor board on the reading device that a barcode is present. In addition, the summary information includes a count as to how many barcodes (other than the summary barcodes) appear on the paper record for a voting session so that the reader device can recognize if any expected barcodes were not read.

Of course, the format of the indicia printed on the voting record may vary depending on the manufacturer and model of voting machine that created the paper record. Thus, the voting record depicted in FIGS. 8 and 9 is exemplary and not limiting in scope. Preferably, the machine-readable indicia is a barcode and, most preferably, a two-dimensional barcode of any known format, such as PDF417, DataMatrix, MaxiCode, QR Code, or other formats known in the art.

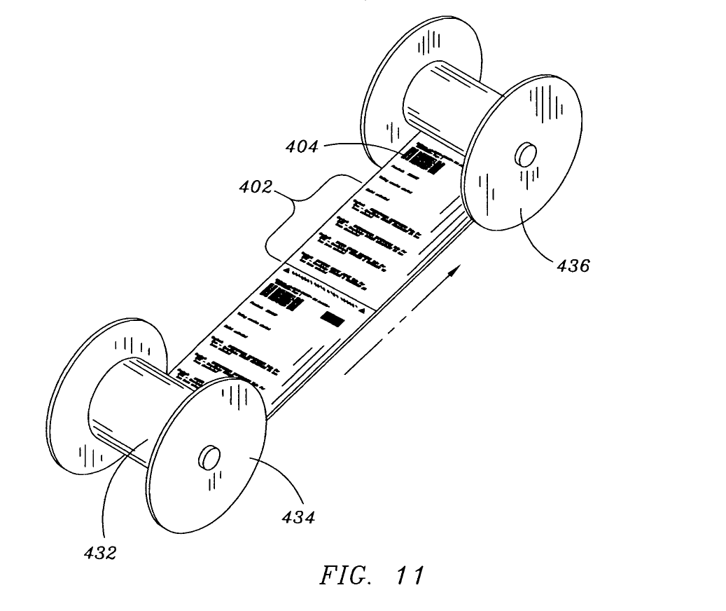

Looking now to FIG. 10, a voting record is depicted in the form of an individual paper sheet 414 in which multiple pages are fan-folded into a “Z” shaped pack. As just described, each individual page of the voting record includes human-readable indicia 402 and machine-readable indicia 404 representing information relating to a voting session and votes cast in the voting session. The last page of the fan-fold pack is a summary page (as depicted in FIG. 9) with indicia summarizing the voting session. It should be understood that this fan-fold pack may be used with the device of the second exemplary embodiment described above.

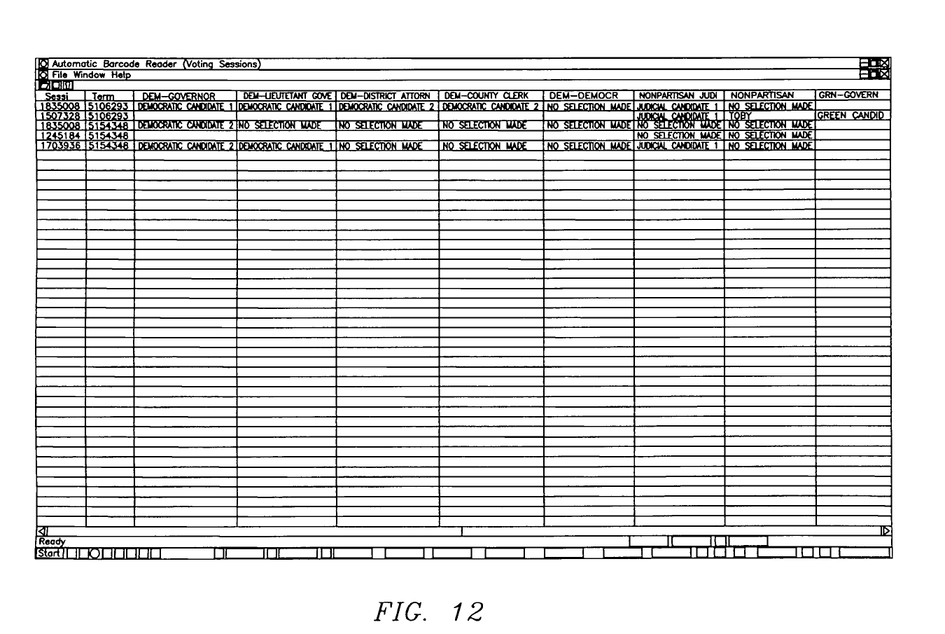

Looking to FIG. 11, a paper record in the form of a continuous paper roll of voting records is depicted. Similar to the fan-fold pack just described, each voting record on the paper roll may comprise multiple consecutive pages of human-readable indicia 402 and machine-readable indicia 404. The paper roll will also include voting records from multiple other voting sessions. As is apparent, the paper roll will likewise include a summary page for each voting session comprising multiple barcodes as described above and depicted in FIG. 9. It should be understood that this paper roll may be used with the device of the first exemplary embodiment described above.

### Computer System

As seen in FIG. 7, a computer system 330 communicates with the controller/logic board 300 via USB interface 314. As the controller/logic board receives data (i.e., voting session information) decoded from the barcodes on the voting records as previously described, the controller/logic board transmits that data to the computer system 330 through the USB interface 314.

A data verification software program running on the computer system 330 is operable to receive the data from the USB interface 314, and to aggregate, tally, collect, report, and otherwise operate on the received data. In addition, the software is operable to store the received data to a storage medium, such as a hard disc drive, so that different reports within the data verification program can be run without having to re-run the paper record through the reading device. Preferably, the raw barcode data received from the reading device is stored in a flat text file format to allow easy viewing and inspection of the data. The data verification software program is configured to provide various reports of the received data, depending upon selections made by the user. Preferably, the computer system is a personal computer running the Windows® operating system, and the data verification program is a Visual Basic® program operable to receive the transmitted data from the USB interface of the computer system 330, aggregate and tally the data according to the requirements of the specific report requested by the user, and report the data on a computer monitor or printer for viewing by a user. Most preferably, the software program implements a graphical user interface (GUI) for allowing a user to select desired reports to view the received data, save the data, and communicate with the input and output devices and ports of the computer system. Preferably, the software program communicates with the reading device to receive any error logs or reports generated by the device and to store those reports for viewing by a user.

Of course, the data verification program may be implemented in other languages, or within other applications without deviating from the present invention. For example, the data verification program could be implemented as one or more Excel® spreadsheets, operable to retrieve the transmitted data directly from the USB interface, or to indirectly receive the data from an intermediate file or memory location, with a driver program collecting the transmitted data from the USB interface and storing it for retrieval in the intermediate location. The transmitted data may be collected by a program implementing a Dynamic Data Exchange (DDE) protocol, a standard protocol allowing various software programs to exchange data through various interfaces. These and other variations of the data verification program will be apparent to those skilled in the art, and are all contemplated by the present invention.

While the exemplary computer system and data verification software program are described herein with reference to the exemplary reading devices described above, it will be understood that the computer system and software may also be used with other reader and/or scanner devices capable of reading the machine-readable indicia from the paper record and transmitting that data to the computer system.

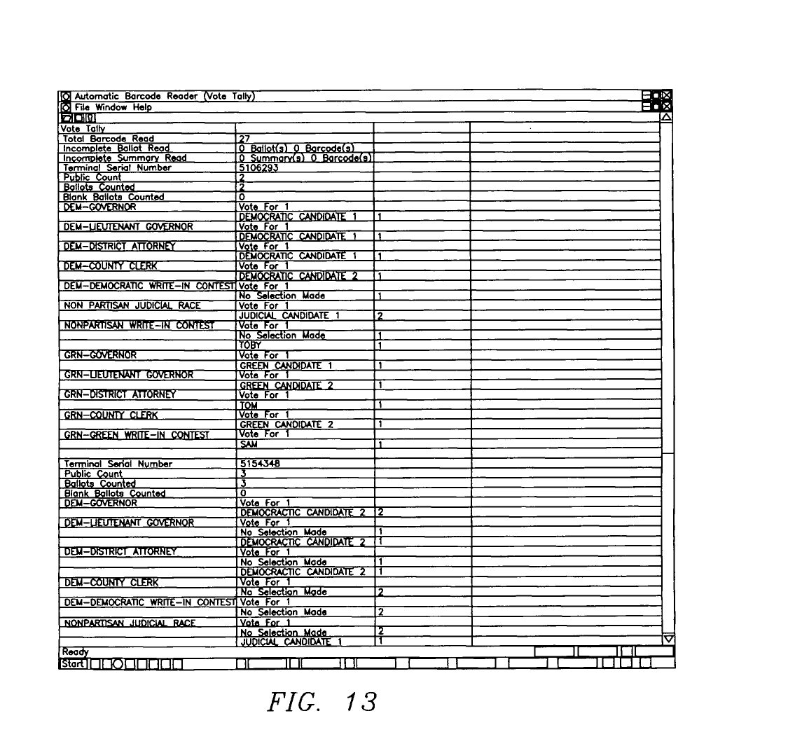

Looking to FIG. 12, an exemplary voting sessions report generated by the data verification program of the present invention is depicted. In this exemplary report, the data received from the reading device is displayed for each voting session. Specifically, the row for each voting session displays the unique voting session identifier, the voting terminal identification number, and the selected candidate (or “no selection made”) for each of the races identified in the column headings. For example, looking to the first row of the report depicted in FIG. 12, the unique voting session identifier is “1835008” and the terminal identification number is “5106293.” In the “DEM-GOVERNOR” race (third column), the voter selected “Democratic Candidate 1”; in the “DEM-LIEUTENANT GOV” race (fourth column), the voter selected “Democratic Candidate 1”; and so forth for each of the races shown in the column headings. Thus, using this report generated independently of the voting machine on which the voters cast his or her votes, a user can audit and verify the selections made in a particular voting session. That information can be compared to electronic records from the voting machine to provide an independent verification of the voting session results stored within the voting machine.

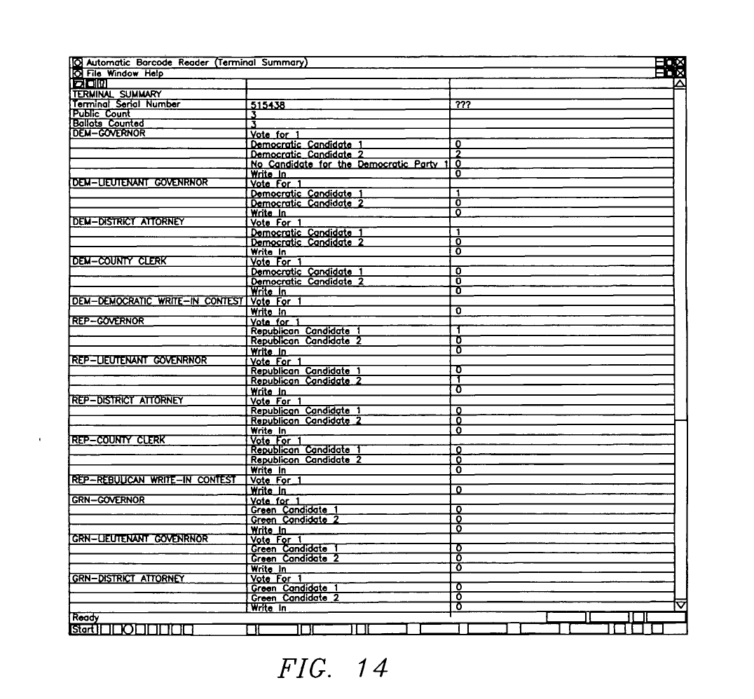

Looking to FIG. 13, an exemplary vote tally report generated by the data verification program of the present invention is depicted. In this exemplary report, the data received from the reading device is displayed in a vote tally format, along with the aggregated results of multiple voting sessions from multiple voting machines. Administrative and identification information is also displayed. Looking towards the top of the report, the “Total Barcode Read” row reports the number of barcodes (27) read by the device. The report also reports an “Incomplete Ballot Read” total, and an “Incomplete Summary Read” total (referring to the summary barcodes at the end of each of the voting records).

The report also displays vote tallies by terminal serial number, with rows for “Terminal Serial Number” (identifying the serial number of the voting terminal that generated the paper record being audited), ““Public Count” field (indicating “validated” when all individual voting sessions from a particular voting terminal have been checked and verified against the summary information at the end of the paper roll or pack of paper sheets, as described above), “Ballot Counted” (reporting the total number of ballots or voting records counted), and “Blank Ballots Counted” (reporting the total number of blank ballots or voting records counted). Further, the remaining rows display a vote tally for each race/candidate of the election being reported. For example, in the “DEM-GOVERNOR” race, democratic candidate 1 received 1 vote; in the “NONPARTISIAN JUDICIAL RACE”, judicial candidate 1 received 1 vote; and so forth. Looking just past halfway down on the report, the tally results for another voting terminal (Terminal Serial Number 5154348) begin and are similar to that just described. Thus, using this report, a user can determine the vote tallies in particular races by the terminal serial number. The information in the report can then be compared with the vote tallies stored electronically within the voting machine to provide an independent verification of the accuracy of the electronic vote tallies.

Looking now to FIG. 14, an exemplary terminal summary report generated by the data verification program of the present invention is depicted. In this exemplary report, the data received from the reading device is displayed in a terminal summary format, with the aggregated results of multiple voting sessions from a particular voting terminal displayed along with administrative and identification information for that voting terminal. Looking towards the top of the report, the “Terminal Serial Number” of the voting terminal is displayed, along with a “Public Count” field (indicating “validated” when all individual voting sessions from a particular voting terminal have been checked and verified against the summary information at the end of the paper roll or pack of paper sheets, as described above), and “Ballots Counted” (reporting the total number of ballots or voting records counted). In a manner similar to that described above, the remaining rows display vote tallies for individual races in the election for that specific voting terminal. For example, in the “DEM GOVERNOR” race, two votes total were cast for democratic candidate 2. Thus, using this report, a user can verify the vote tallies in particular races for a particular voting terminal. That information can be compared with results taken from the voting machine to provide an independent verification of the voting terminal results provided by the voting machine.

Of course, those skilled in the art will appreciate that other types of reports with other combinations of information may be displayed and/or printed in accordance with the present invention. Any of the information decoded from the barcodes on the voting records and received from the reading device may be aggregated, counted, or otherwise reported in a manner similar to the reports just described. It will also be appreciated by those skilled in the art that the format of the reports may be varied from those shown in the exemplary reports just described.

### Operation

With the exemplary reading devices and computer system disclosed and described above, the operation of an exemplary system in accordance with the present invention will now be described with reference to FIGS. 1-16.

In the case of a continuous paper roll of voting records, looking first to FIG. 3 in conjunction with the block diagram of FIG. 7, a user loads the paper roll into the reading device by feeding the paper roll from the supply reel 34 to the take-up reel 36 and routing the paper roll under the paper guides 44a, 44b. As such, the voting records will be transported across paper transport area 46 and under sensor board 48 and reader 50. With the paper roll loaded, cover 16 is closed. With the device connected to the computer system 330 through the USB interface 314, the user powers-on the device and toggles the “mode” of operation to automatic. Looking still to FIG. 7, in “automatic” mode, microcontroller 302 on controller/logic board 300 commands the stepper motor controller 1 (308) and stepper motor controller 2 (310) to actuate the corresponding stepper motors so that the paper roll is advanced from the supply reel to the take up reel.

Looking to FIG. 2, as the paper roll advances from the supply reel to the take-up reel, the voting records on the paper roll are viewable through the window 26 in cover 16. Thus, a user can see and read the human-readable indicia on each voting record as it passes under the window 26. In addition, looking to FIG. 3 in conjunction with FIGS. 8 and 9, as the paper roll advances from the supply reel to the take-up reel, the voting records on the paper roll are moved across the paper transport area 46 and pass under sensor board 48 and reader 50 (corresponding to sensor 318 and reader 328 of FIG. 7). When a timing mark 406 is detected by the sensor board 48, the sensor board 48 transmits a signal to controller/logic board 300 indicating that a timing mark has been detected and that a barcode is thus in position to be read. Microcontroller 302 then communicates with the reader 50 and receives an electronic data stream as the reader 50 decodes the barcode from the paper roll. It should be understood that the data stream represents the voting session information encoded in the barcode. When the microcontroller has received the data from the reader 50, the controller/logic board transmits the voting session information through the USB interface to computer system 330, where the information is aggregated and reported as described above. As the paper roll is advanced through the paper transport area 46, additional voting records are detected by the sensor board 48, read by the reader 50, and the corresponding voting session information is passed to computer system 330.

As each barcode is successfully read by the reader 50 and the data is received by the microcontroller, the controller/logic board indicates the successful read of the barcode by briefly illuminating the “read’ light on the control panel 28. In the event a barcode is not successfully decoded, such as if the reader 50 cannot decode the information from the barcode or if there is an error in transmitting the data from the reader 50 to the microcontroller, then the controller/logic board will stop the transport of the paper roll through the device and illuminate the “error” light of control panel 28. Upon such an error, a user can use the “reverse” button to rewind the paper roll, then switch to “automatic” mode to restart the process and attempt to read the barcode again. If the error repeats, or if the user so chooses, the human-readable indicia corresponding to the unreadable barcode can be viewed (through viewing window 26) and noted, and that information can be manually entered into computer system 330. Preferably, if the user rewinds the paper roll too far and duplicate information is read (i.e., the same record is read more than once), the aggregating and tallying software on computer system 330 will detect the duplication and will not double-count the votes on that voting record.

Upon completion of reading the multiple voting records on the paper roll, the user can open the cover and load further rolls of paper as necessary to aggregate all of the information from an election, from a particular voting machine, or other criteria for selecting the voting records to be read. After all of the desired voting records have been read by the device, the computer system 330 is used to aggregate, tally, and report the results as described above.

In a manner similar to that just described for the reel-to-reel paper roll reading device, the device of FIG. 6 is used to read individual paper sheets (usually in a fanfold pack as depicted in FIG. 10). In this case, there is only an “automatic” mode of operation. First, a user powers on the device and feeds an individual paper sheet through a slot and under feed drive 234. As the user feeds the paper sheet into the device, the sensor board detects the leading edge of the paper sheet and signals the controller/logic board. The controller/logic board commands the feed drive motor 234 to actuate, whereby the feed drive 234 automatically pulls the entire paper sheet through the device.

As the paper sheet advances through the feed drive 234, the paper sheet moves across paper transport area 246 and passes under sensor board 248 and reader 250 (corresponding to sensor 318 and reader 328 of FIG. 7). When a timing mark 406 is detected by the sensor board 248, the sensor board 248 transmits a signal to controller/logic board 300 indicating that a timing mark has been detected and that a barcode is in position to be read. Microcontroller 302 then communicates with the reader 250 and receives an electronic data stream from the reader 250 as the reader decodes the barcodes from the paper sheet. When the microcontroller has received the data from the reader 250, the controller/logic board transmits the voting session information through the USB interface to computer system 330, where the information is aggregated and reported as described above. As the paper sheet is advanced through the paper transport area 246, additional timing marks are detected by the sensor board 248, additional barcodes are read by the reader 250, and the corresponding voting session information is passed to computer system 330.

As each barcode is successfully read by the reader 250 and the data is received by the microcontroller, the controller/logic board indicates the successful read by briefly illuminating the “read’ light on the control panel 28. In the event a barcode is not successfully decoded, such as if the reader 250 cannot decode the information from the barcode or if there is an error in transmitting the data from the reader 250 to the microcontroller, then the controller/logic board will stop the transport of the paper roll through the device and illuminate the “error” light of control panel 28. Upon such an error, a user can use the “reverse” button to retract the paper sheet and attempt to read the barcode again, or can manually remove and/or retract the paper sheet and re-feed it into the reader. If the error repeats, or if the user so chooses, the human-readable indicia corresponding to the unreadable barcode can be viewed through viewing window 26 and noted, whereby the information can be manually entered into computer system 330. If the user retracts the paper sheet too far and duplicate information is read (i.e., the same record is read more than once), the aggregating and tallying software on computer system 330 will detect the duplication and will not double-count that voting record.

Upon completion of reading the individual paper sheet, the user can continue to feed additional paper sheets into the reading device as necessary to aggregate all of the information from an entire election, from a particular voting machine, or other criteria for selecting the voting records to be read. After all of the desired voting records have been read by the device, the computer system 330 is used to aggregate, tally, and report the results as described above.

As can be seen, the system and method of the present invention allows independent verification of the votes cast in an election. Importantly, the system operates independently of the voting machine that produced the paper record. The system allows a user to manually review the votes recorded on the paper record, or to automatically tally, aggregate, and report the information stored on the paper record as desired by the user. The user can then use that information to verify the accuracy of the results provided by the voting machine.

While the present invention has been described and illustrated hereinabove with reference to several exemplary embodiments, it should be understood that various modifications could be made to these embodiments without departing from the scope of the invention. Therefore, the invention is not to be limited to the specific embodiments described and illustrated hereinabove, except insofar as such limitations are included in the following claims.

What is claimed and desired to be secured by Letters Patent is as follows:

1. A device for independently auditing a paper record of votes cast on a voting machine, comprising:
a paper transport area;
a transport mechanism operable to transport said paper record across said paper transport area; and
a reader positioned proximate said paper transport area and operable to read at least a portion of said paper record when said paper record is transported across said paper transport area.

2. The device of claim 1, wherein said paper record comprises a plurality of voting records each of which presents a record of votes cast by a voter during a voting session on said voting machine.

3. The device of claim 2, wherein said paper record comprises a continuous paper roll of voting records associated with said voting machine, and wherein said transport mechanism comprises a supply reel and a take-up reel operable to transport said paper roll from said supply reel to said take-up reel across said paper transport area.

4. The device of claim 2, wherein said paper record comprises a plurality of individual paper sheets each of which comprises one of said voting records associated with said voting machine, and wherein said transport mechanism comprises a feed-drive operable to transport each of said paper sheets across said paper transport area.

5. The device of claim 2, wherein each of said voting records presents voting session information that is human-readable and/or machine-readable.

6. The device of claim 5, wherein said voting session information comprises at least one barcode, and wherein said reader comprises a barcode reader operable to read said barcode presented on said voting record.

7. The device of claim 6, wherein said at least one barcode comprises encoded data selected from the following group: a vote summary, a unique voting session identifier, polling place identification information, and combinations thereof.

8. The device of claim 6, wherein said at least one barcode comprises a two-dimensional barcode.

9. The device of claim 1, wherein said device operates independently of said voting machine.

10. The device of claim 1, further comprising a window positioned proximate said paper transport area such that said paper record is viewable through said window when said paper record is transported across said paper transport area.

11. The device of claim 1, further comprising a plurality of user-operable controls in communication with said transport mechanism and operable to control movement of said paper record across said paper transport area.

12. A device for independently auditing a paper record of votes cast on a voting g machine, comprising:
a paper transport area;
a transport mechanism operable to transport said paper record across said paper transport area; and
a window positioned proximate said paper transport area such that said paper record is viewable through said window when said paper record is transported across said paper transport area.

13. The device of claim 12, wherein said paper record comprises a plurality of voting records each of which presents a record of votes cast by a voter during a voting session on said voting machine.

14. The device of claim 13, wherein said paper record comprises a continuous paper roll of voting records associated with said voting machine, and wherein said transport mechanism comprises a supply reel and a take-up reel operable to transport said paper roll from said supply reel to said take-up reel across said paper transport area.

15. The device of claim 12, wherein said device operates independently of said voting machine.

16. The device of claim 12, further comprising a plurality of user-operable controls in communication with said transport mechanism and operable to control movement of said paper record across said paper transport area.

17. A computer-readable medium having computer-executable instructions for performing a method of independently auditing a paper record of votes cast on a voting machine, said method comprising:
receiving data corresponding to a plurality of voting records;
processing at least a portion of said data to generate a plurality of vote tallies for said voting machine; and
outputting at least a portion of said data and/or said vote tallies for review by a user.

18. The computer-readable medium of claim 17, wherein said data for each of said voting records is selected from the following group: a vote summary, a unique voting session identifier, polling place identification information, and combinations thereof.

19. The computer-readable medium of claim 17, wherein at least a portion of said data and/or said vote tallies are displayed on a computer screen.

20. The computer-readable medium of claim 17, wherein at least a portion of said data and/or said vote tallies are printed on a printable medium.

21. A method for independently auditing a paper record of votes cast on a voting machine, comprising:
receiving a paper record comprising a plurality of voting records each of which presents a record of votes cast by a voter during a voting session on said voting machine;
reading at least a portion of said paper record to obtain data corresponding to each of said voting records;
processing at least a portion of said data to generate a plurality of vote tallies for said voting machine; and
outputting at least a portion of said data and/or said vote tallies for review by a user.

22. The method of claim 21, wherein each of said voting records presents voting session information that is human-readable and/or machine-readable.

23. The method of claim 22, wherein said voting session information comprises at least one barcode.

24. The method of claim 23, wherein said at least one barcode comprises encoded data selected from the following group: a vote summary, a unique voting session identifier, polling place identification information, and combinations thereof.

25. The method of claim 23, wherein said at least one barcode comprises a two-dimensional barcode.

26. The method of claim 21, further comprising displaying at least a portion of said data and/or said vote tallies on a computer screen.

28. The method of claim 21, farther comprising printing at least a portion of said data and/or said vote tallies on a printable medium.

29. A system for independently auditing a paper record of votes cast on a voting machine, comprising:
an automated reading device comprising: a paper transport area; a transport mechanism operable to transport said paper record across said paper transport area; and a reader positioned proximate said paper transport area and operable to read at least a portion of said paper record when said paper record is transported across said paper transport area; wherein said paper record comprises a plurality of voting records each of which presents a record of votes cast by a voter during a voting session on said voting machine; and
a computing device in communication with said automated reading device and operable to: receive data corresponding to each of said voting records from said automated reading device; process at least a portion of said data to generate a plurality of vote tallies for said voting machine; and output at least a portion of said data and/or said vote tallies for review by a user.

30. The system of claim 29, wherein said paper record comprises a continuous paper roll of voting records associated with said voting machine, and wherein said transport mechanism comprises a supply reel and a take-up reel operable to transport said paper roll from said supply reel to said take-up reel across said paper transport area.

31. The system of claim 29, wherein said paper record comprises a plurality of individual paper sheets each of which comprises one of said voting records associated with said voting machine, and wherein said transport mechanism comprises a feed-drive operable to transport each of said paper sheets across said paper transport area.

32. The system of claim 29, wherein each of said voting records presents voting session information that is human-readable and/or machine-readable.

33. The system of claim 32, wherein said voting session information comprises at least one barcode, and wherein said reader comprises a barcode reader operable to read said barcode presented on said voting record.

34. The system of claim 33, wherein said at least one barcode comprises encoded data selected from the following group: a vote summary, a unique voting session identifier, polling place identification information, and combinations thereof.

35. The system of claim 29, wherein said system operates independently of said voting machine.

36. The system of claim 29, wherein at least a portion of said data and/or said vote tallies are displayed on a computer screen.

37. The system of claim 29, wherein at least a portion of said data and/or said vote tallies are printed on a printable medium.
